(19) United States
(12) Patent Application Publication
(10) Pub. No.: US 2013/0027270 A1
(43) Pub. Date: Jan. 31, 2013

(54) METAL COVERS FOR RADIO COMMUNICATION DEVICES

(71) Applicants: Axel von Arbin, Taby (SE); Per Erlandsson, Stockholm (SE)

(72) Inventors: Axel von Arbin, Taby (SE); Per Erlandsson, Stockholm (SE)

(21) Appl. No.: 13/633,650

(22) Filed: Oct. 2, 2012

Related U.S. Application Data
(63) Continuation of application No. PCT/SE2011/050477, filed on Apr. 19, 2011.

(30) Foreign Application Priority Data
Apr. 29, 2010 (EP) 10161409.7

(51) Int. Cl. H01Q 1/42; H01Q 1/52

(52) U.S. Cl. 343/841; 343/872

(57) ABSTRACT

An exemplary embodiment of an antenna system includes a metal cover for a radio communication device and a complementary antenna. The metal cover includes front side part, a first back side part connected to the front side part through a top side part, and a second back side part connected to the front side part through a bottom side part. The bottom and top side parts are positioned at opposite ends of the front side part. The first and second back side parts are positioned essentially coplanar and distanced from each other by a gap. The front side part comprises a recess at the bottom side part and/or at the top side part in which recess the complementary antenna is positioned in.

### CROSS-REFERENCE TO RELATED APPLICATIONS

This application is a continuation of PCT International Patent Application No. PCT/SE2011/050477 filed Apr. 19, 2011, published as WO2011/136720 which, in turn, claims priority of European patent application No. 10161409.7 filed Apr. 29, 2010, published as EP 2,387,100. The entire disclosures of the above applications are incorporated herein by reference.

### FIELD

The present disclosure relates generally to covers for radio communication devices, and more particularly to metal covers for radio communication devices.

### BACKGROUND

This section provides background information related to the present disclosure which is not necessarily prior art.

A current trend for portable radio communication devices, such as mobile phones, PDA, portable computers and similar devices, is to provide the device with a metal cover. A metal cover for a portable radio communication device makes it difficult to provide the device with a non-protruding antenna, as the metal cover shields the inner of the device for radio frequencies. It is possible to only partly provide the cover as a metal cover, to allow the use of a built in antenna, but it would be desirable to provide a full metal cover.

Another trend for portable radio communication devices, such as mobile phones and similar devices, is to provide the device with a very broadband coverage, covering e.g., GSM850, GSM900, GSM1800, GSM1900, UMTS 2100 MHz, GPS, BT and WLAN 2.4 GHz. This puts further restrictions on the design of an antenna for a portable radio communication device.

### SUMMARY

This section provides a general summary of the disclosure, and is not a comprehensive disclosure of its full scope or all of its features.

Exemplary embodiments are disclosed of antenna systems that comprise a metal cover for a radio communication device. Exemplary embodiments are also disclosed of radio communication devices including such antenna systems.

An exemplary embodiment of an antenna system includes a metal cover for a radio communication device and a complementary antenna. The metal cover includes front side part, a first back side part connected to the front side part through a top side part, and a second back side part connected to the front side part through a bottom side part. The bottom and top side parts are positioned at opposite ends of the front side part. The first and second back side parts are positioned essentially coplanar and distanced from each other by a gap. The front side part comprises a recess at the bottom side part and/or at the top side part in which recess the complementary antenna is positioned in.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 schematically shows a front side of a metal cover for a mobile phone.

FIG. 2 schematically shows a back side of a metal cover for a mobile phone according to a first exemplary embodiment.

FIG. 3 schematically shows a side view from the left of a variant of the metal cover shown in FIG. 2.

FIG. 4 schematically shows a side view from the right of a variant of the metal cover shown in FIG. 2.

FIG. 5 schematically shows a back side of a metal cover for a mobile phone according to a second exemplary embodiment.

### DETAILED DESCRIPTION

Example embodiments will now be described more fully with reference to the accompanying drawings.

Exemplary embodiments are disclosed of antenna systems that comprise a metal cover for a radio communication device, which allow a non-protruding antenna. Exemplary embodiments are also disclosed of radio communication devices including such antenna systems.

In an exemplary embodiment, an antenna system comprises a metal cover for a radio communication device and a complementary antenna. The metal cover includes a front side part, a first back side part connected to the front side part through a top side part, and a second back side part connected to the front side part through a bottom side part. The top and bottom side parts are positioned on opposite sides of the front side part. The first and second back side parts are positioned coplanar and distanced from each other by a gap of preferably at least 0.5 millimeters (mm). The front side part includes a recess at the top side part and/or at the bottom side part, in which recess the complementary antenna is positioned in. Accordingly, this exemplary embodiment can provide a full metal cover having a non-protruding antenna.

Providing a broad high-frequency band is facilitated by preferably having a feed point and a ground point, wherein the feed point is positioned at the gap and the ground point is positioned along a side edge of the first back side part. The feed point and ground point are further preferably positioned at opposite corners of the first back side part, to further facilitate providing the broad high-frequency band.

The second back side part is advantageously provided with a feed point at the gap, preferably at a corner opposite the feed point of the first back side part, to facilitate providing a broad low-frequency band. To broaden the high and low frequency bands, the first and second back side parts preferably comprises edge portions folded down towards the front side part. Although exemplary embodiments are particularly useful for portable radio communication devices, they are also applicable to fixed radio communication devices such as base stations.

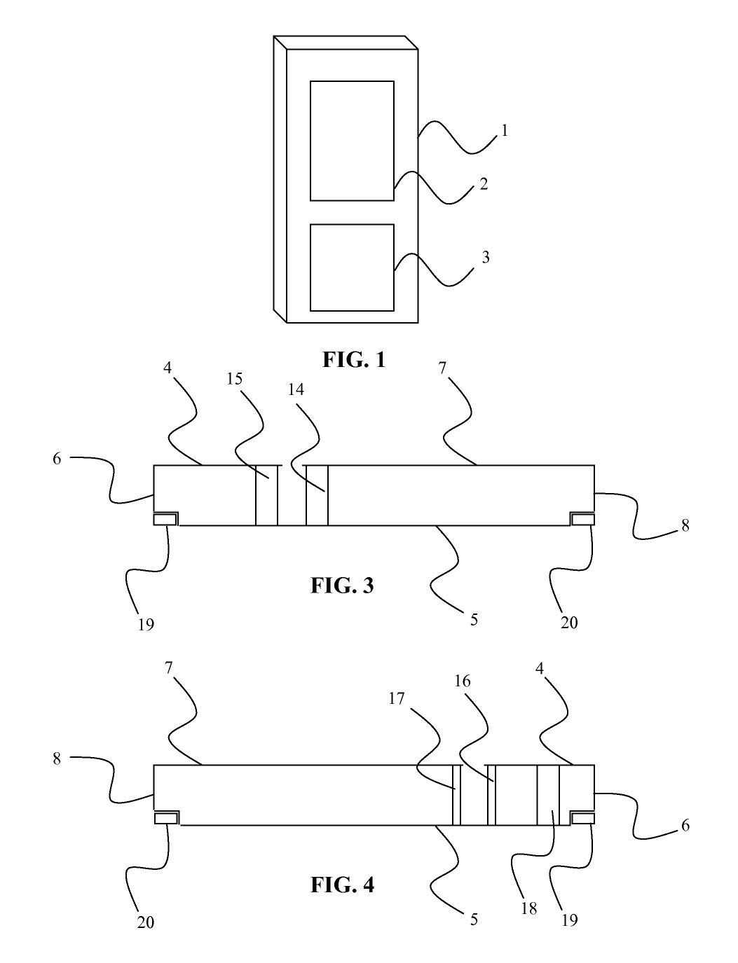

A portable radio communication device comprising an antenna system having a metal cover according to a first exemplary embodiment will now be described with reference to FIGS. 1-3. As shown in FIG. 1, the portable radio communication device, such as a mobile phone, has a sheet metal cover 1. A display 2 is mounted in a front side of the sheet metal cover 1. And, a key pad 3 is also mounted in the front side of the sheet metal cover 1. Components for operation of the portable radio communication device is as usually provided within its housing, which in this exemplary embodiment the components are within the sheet metal cover 1. The display 2 and key pad 3 is alternatively replaced by a preferably larger touch screen occupying a major part of the front side of the sheet metal cover 1.

The back side of the metal cover 1 is divided into two parts. A first back side part 4 is connected to the front side part 5 of the metal cover through a top side part 6. A second back side part 7 is connected to the front side part 5 of the metal cover through a bottom side part 8. The first back side part 4 and the second back side part 7 are essentially coplanar and distanced from each other by a gap of about 2-5 mm.

The first back side part 4 is driven as a multi-band antenna element by being fed at a feed point 9 at a corner near the gap against the second back side part 7, by being grounded at a ground point 10 at an opposite corner near the gap against the second back side part, and by being grounded along the top side part 6. For a mobile phone, and thus its metal cover, having a length of about 110 mm, a width of about 50 mm, and a thickness of about 9 mm, a frequency band coverage of about 1550-2500 Megahertz (MHz) is achievable. The first back side part 4 has a generally rectangular shape having a length of about 33 mm and a width of about 50 mm, in this example. Alternatively, the feed point is preferably positioned at the gap somewhere between the corner near the gap and the middle along the side of the gap of the first back side part, and the ground point is preferably positioned somewhere along a side edge away from the feed point of the first back side part.

The second back side part 7 is driven as an antenna element by being fed at a feed point 11 at a corner near the gap against the first back side part 4, and by being grounded along the bottom side part 8. For a mobile phone, and thus its metal cover, having a length of about 110 mm, a width of about 50 mm, and a thickness of about 9 mm, a frequency band coverage of about 750-1050 MHz is achievable. The second back side part 7 has a generally rectangular shape having a length of about 72 mm and a width of about 50 mm, in this example.

The first and second back side parts are functioning as radiating elements over a ground plane, i.e., over the front side part. In this way, a robust antenna is achieved by the first and second back side parts, respectively, are connected to the front side through a large grounding means, i.e., the top and bottom side parts, respectively. A display device and/or a key pad are typically provided with grounded shielding means between the inner of the radio communication device and the display device and/or the key pad. The grounded shielding means then form part of the front side part. Further, in a mobile phone e.g. having a touch screen occupying essentially the whole front thereof, the front side part of the metal cover will then be made up by the shielding means of the touch screen.

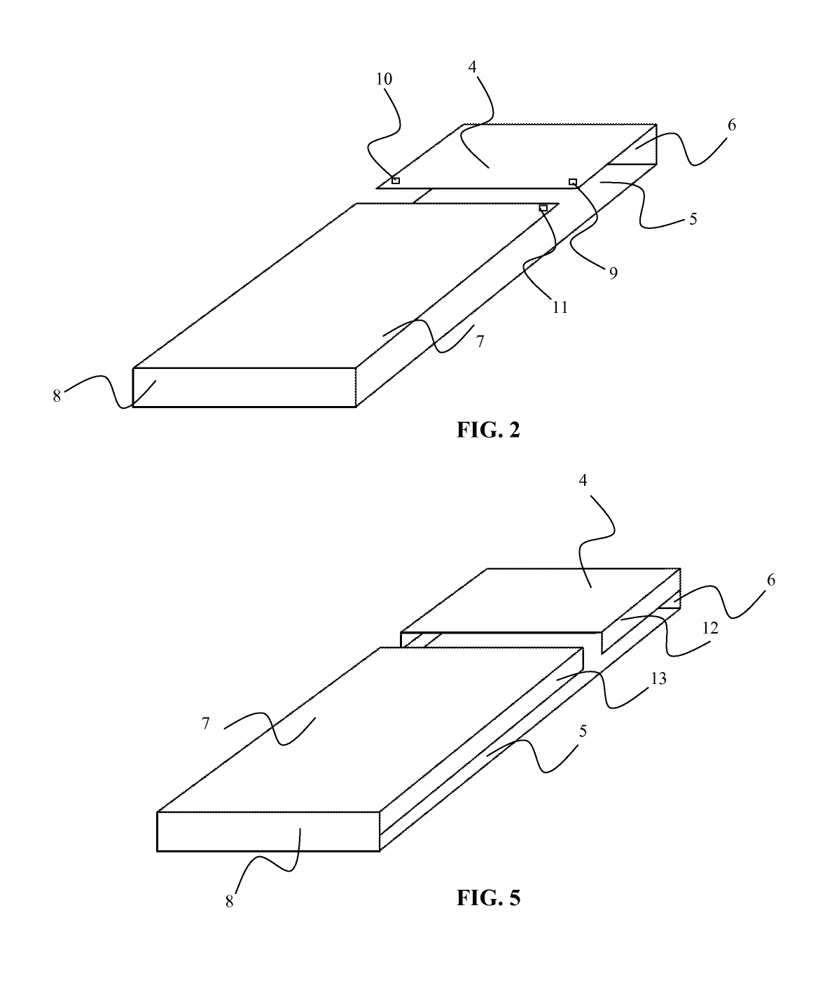

The antenna system further comprises a first complementary antenna 19 (not illustrated in FIG. 2), and preferably also a second complementary antenna 20 (not illustrated in FIG. 2). The front side part 5 comprises a first recess for accommodating the first complementary antenna 19 and preferably also a second recess for accommodating the second complementary antenna 20. The first recess is at the top side part 6. The second recess is at the bottom side part 8 of the metal cover. By providing the complementary antennas 19, 20 at the ends of the front side part 5, the thereby reduced height to the first and second back side parts does not particularly influence the performance of the antenna provided through the metal cover.

The complementary antennas 19, 20 are preferably realized as a monopole for FM Rx, a half loop for FM Tx, and a multiple-turn loop antenna folded over the edge for the NFC antenna. The GPS and BT antennas are preferably IFAs, monopoles, or half loop antennas. The first complementary antenna 19 preferably covers NFC. The second complementary antenna 20 preferably covers GPS, BT and/or FM.

The first and second back side parts 4, 7 have been described as having feed points 9 and 11. Feeding of the feed points 9 and 11 is advantageously provided as two separate feedings to RF circuitry, to improve isolation therebetween. But the feeding of the feed points 9 and 11 could alternatively be provided as a common feeding having filtering means to separate signaling to and from RF circuitry.

The second back side part 7 preferably covers the whole battery of a mobile phone. The second back side part 7 is preferably pivotable around and/or detachably attached to the bottom side part to facilitate access into the mobile phone e.g., changing a battery or for changing a SIM of the mobile phone.

The top and bottom side parts have been illustrated as parts covering the top and bottom side, respectively, of the portable radio communication device. But they can alternatively comprise a plurality of grounding portions together not covering the top or bottom side, respectively.

For improved antenna function, the metal cover is preferably made up by or metalized by a good conductive material.

For tuning of the antenna made up by the metal cover 1, additional grounding is preferably added at the sides of the portable radio communication device. FIG. 3 illustrates a wide grounding 15 to ground point 10 as well as a wide grounding 14 of the second back side part 7. FIG. 4 illustrates an additional wide grounding 18 of the first back side part 4, feeding 16 to feed point 9, and feeding 17 to feed point 11.

Although the first back side part has been described as generating the high frequency band and the second back side part has been described as generating the low frequency band, the opposite is also possible. Also, either the first or the second back side part could generate both low and high frequency bands.

A portable radio communication device according to a second exemplary embodiment will next be described with reference to FIG. 5. This second exemplary embodiment is similar to the first exemplary embodiment described above apart from that the first and second back side parts comprise folded side edge portions extending towards the front side part, e.g., extending about 6 mm and thus leaving a gap of about 3 mm to the front side part. Although the folded side edge portions have been illustrated as covering the whole first and second back side parts, it is also possible to only have portions of the first and second back side part edges folded towards the front side part. The first complementary antenna and/or second complementary antennas are not illustrated in FIG. 5.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms (e.g., different materials, etc.), and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values (e.g., frequency ranges or bandwidths, etc.) for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). Similarly, it is envisioned that disclosure of two or more ranges of values for a parameter (whether such ranges are nested, overlapping or distinct) subsume all possible combination of ranges for the value that might be claimed using endpoints of the disclosed ranges.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An antenna system comprising a metal cover for a radio communication device and a complementary antenna, wherein the metal cover comprises:
a front side part;
a first back side part connected to the front side part through a top side part; and
a second back side part connected to the front side part through a bottom side part;
wherein:
the bottom and top side parts are positioned at opposite ends of the front side part;
the first and second back side parts are positioned essentially coplanar and distanced from each other by a gap; and
the front side part comprises a recess at the top side part and/or the bottom side part, in which recess the complementary antenna is positioned.

2. The antenna system according to claim 1, wherein:
the first back side part comprises a feed point and a ground point;
the feed point is positioned at the gap; and
the ground point is positioned along a side edge of the first back side part.

3. The antenna system according to claim 2, wherein:
the feed point is positioned at a corner at the gap; and
the ground point is positioned at a corner at the gap, opposite the corner at which the feed point is positioned.

4. The antenna system according to claim 1, wherein the front side part comprises a recess at the top side part and at the bottom side part, in which recesses complementary antennas are positioned.

5. The antenna system according to claim 1, wherein the second back side part comprises a feed point positioned at the gap.

6. The antenna system according to claim 1, wherein the second back side part comprises a ground point.

7. The antenna system according to claim 1, wherein:
the first back side part is configured to cover GSM1800, GSM1900, UMTS 2100 MHz, GPS, BT and WLAN 2.4 GHz; and
the complementary antenna is configured to cover FM and NFC.

8. The antenna system according to claim 7, wherein the first back side part is configured to also cover GSM850 and GSM900.

9. The antenna system according to claim 1, wherein:
the second back side part is configured to cover GSM850 and GSM900; and
the complementary antenna is configured to cover FM, NFC, and optionally BT and GPS.

10. The antenna system according to claim 9, wherein the second back side part is configured to also cover GSM1800, GSM1900, UMTS 2100 MHz, GPS, BT and WLAN 2.4 GHz.

11. The antenna system according to claim 1, wherein the complementary antenna is configured to cover BT and/or GPS.

12. The antenna system according to a claim 1, wherein:
the first back side part is instead connected to the front side part through the bottom side part; and
the second back side part is instead connected to the front side part through the top side part.

13. The antenna system according to claim 1, wherein the front side part comprises grounded shielding means of a display device of the radio communication device.

14. The antenna system according to claim 1, wherein the front side part comprises ground plane means of the radio communication device.

15. The antenna system according to claim 1, wherein the radio communication device is portable.

16. A radio communication device comprising an antenna system according to claim 1.
